(19) United States
(12) Patent Application Publication
(10) Pub. No.: US 2020/0094537 A1
(43) Pub. Date: Mar. 26, 2020

(54) Fluoropolymer Articles and Related Methods

(71) Applicant: 3M INNOVATIVE PROPERTIES COMPANY, St. Paul, MN (US)

(72) Inventors: Pingfan Wu, Woodbury, MN (US); Timothy J. Hebrink, Scandia, MN (US); Moses M. David, Woodbury, MN (US); Chris A. Praggastis, Renton, WA (US)

(21) Appl. No.: 16/493,225

(22) PCT Filed: May 3, 2018
(86) PCT No.: PCT/US2018/030844

§ 371 Date: Sep. 11, 2019

Related U.S. Application Data
(60) Provisional application No. 62/504,143, filed on May 10, 2017.

(51) Int. Cl. B32B 27/30; B32B 27/40; B32B 3/30; B32B 7/12; B32B 7/10

(52) U.S. Cl. CPC B32B 27/304; B32B 27/308; B32B 27/40; B32B 3/30; B32B 7/12; B32B 2310/14; B32B 2255/10; B32B 2255/26; B32B 2260/046; B32B 2605/18; B32B 7/10

(57) ABSTRACT

Provided are surfacing films that have a surface layer having opposed first and second major surfaces, the first major surface comprising a fluoropolymer surface and the second major surface optionally comprising a nanostructured surface. A printed layer can be disposed on the second major surface and can be at least partially embedded in the nanostructured surface, if present. As a further option, the fluoropolymer surface can be microreplicated to provide a frictional surface and/or provide aerodynamic drag reduction on aircraft structures. Optionally, the delamination peel strength of the surface layer from the remaining layers can be greater than the tensile strength of the surface layer.

### FIELD OF THE INVENTION

Provided are articles having fluoropolymer surfaces and methods of making and using the same. The provided articles can be deployed as surfacing films disposed on external surfaces of a substrate.

### BACKGROUND

Surface films are free-standing films that can be applied to a given substrate and can serve any of a number of purposes. Materials used for such surface films and their configurations can vary widely based on the industrial or commercial application at hand.

Some surface films are primarily intended to provide surface protection against environmental factors such as rain erosion, sand, or other impacts normally encountered by the substrate during use. Surface protection films can be used, for example, to protect the painted surfaces of automobile, marine, or aircraft body parts. Protective films that use one or more layers of a polyurethane are known, and described in U.S. Pat. No. 5,405,675 (Sawka et al.), in U.S. Pat. No. 5,468,532 (Ho et al.), in U.S. Pat. No. 6,383,644 (Fuchs), and in U.S. Pat. No. 6,607,831 (Ho et al.).

Other films have aerodynamic applications, such as drag-reduction films that are used on the leading surfaces of aircraft to guide air flow over these surfaces and minimize turbulence. Surface features capable of reducing aerodynamic drag are described in U.S. Pat, No. 5,971,326 (Bechert), in U.S. Pat. No. 8,668,166 (Rawlings et al.), and in U.S. Pat. No. 8,678,316 (Rawlings et al.).

Other films have functions that may be primarily aesthetic or graphical in nature—for example, such films could include decorative films used on stainless steel appliances, point-of-purchase displays, plastic extrudate, and commercial graphic films on wall surfaces. Any of these films may be pigmented and color matched to achieve a customized appearance. If such a film is to be disposed on a walking surface, then it may be desirable for a film to provide a frictional surface to prevent pedestrian slippage.

Any combination of the above may be represented in the performance criteria for a given surface film.

### SUMMARY

The engineering of a surface film to retain its functional and aesthetic properties under long-term exposure to harsh environments has been and continues to be a significant technical challenge. Such environments not only include exposure to natural elements such as rain, salt spray, and sand, but also solvents and other chemicals used in operating or cleaning the structures to be protected.

In aerospace applications, polymeric surface films often have limited resistance to hydraulic fluids such as SKYDROL fire-resistant hydraulic fluids, which are generally based on phosphate esters. Commonly used polymers, such as polyurethanes, can soften and degrade with exposure to SKYDROL hydraulic fluids. Moreover, cleaning fluids contain solvents that can erode certain polymeric surface films.

As another example, surfacing tapes often have problems with delamination. Surface films are generally fastened to their underlying substrate surface using an adhesive, such as a pressure-sensitive adhesive. While delamination in one piece may be desirable for ease of removal in controlled environments, such delamination from an aircraft surface in flight can result in the film being trapped by a fin or stabilizer. Such a situation could cause loss of control of the aircraft.

The surfacing films disclosed herein provide an answer to some of these technical shortcomings. These films use a surfacing layer with a fluoropolymer surface that can provide an edge seal against rain erosion and chemical resistance. In some embodiments, these films tend to fragment when removed and resist delamination in one piece when adhered to common substrates.

In a first aspect, a surfacing film is provided. The surfacing film comprises: a surface layer having opposed first and second major surfaces, the first major surface comprising a fluoropolymer surface and the second major surface comprising a nanostructured surface; and a printed layer disposed on the second major surface and at least partially embedded in the nanostructured surface.

In a second aspect, a surfacing film is provided, comprising: a surface layer having opposed first and second major surfaces, wherein the first major surface comprises a fluoropolymer surface; and a microreplicated intermediate layer in contact with the second major surface, wherein the fluoropolymer surface has a microreplicated surface at least partially shaped by the microreplicated intermediate layer.

In a third aspect, a surfacing film is provided, comprising: a surface layer having opposed first and second major surfaces, the first major surface comprising a fluoropolymer surface; a tie layer underlying the surface layer, wherein the surface layer and the tie layer are coextruded layers; and a printed layer disposed on the tie layer.

In a fourth aspect, a surfacing film is provided comprising: a surface layer having opposed first and second major surfaces; and an adhesive layer extending across the second major surface, wherein the first major surface comprises a fluoropolymer surface comprises a microreplicated surface and wherein delamination peel strength of the surface layer from the remaining layers is greater than the tensile strength of the surface layer based on the 180° Peel Test.

In a fifth aspect, a method of using an aforementioned surfacing film is provided, comprising applying the surfacing film to an outer surface of an aircraft component to enhance friction.

In a sixth aspect, a method of making a surfacing film is provided, the method comprising: disposing a printed layer on a support layer to provide a bilayer; and laminating the bilayer to a surface layer having opposing first and second major surfaces, wherein the first major surface comprises a fluoropolymer surface and the second major surface has a nanostructured surface and is in contact with the printed layer.

### BRIEF DESCRIPTION OF THE DRAWINGS

FIGS. 1-5 are an elevational, cross-sectional views of surfacing films according to various embodiments, with some layers shown in exploded view for clarity.

FIG. 6 is a split photograph showing the effect of hydraulic fluid on two different areas of a surfacing film over time.

### DEFINITIONS

As used herein:

“ambient conditions” means at a temperature of 25° C. and a pressure of 1 atmosphere (i.e., 101.3 kPa);

“average” refers to a number average;

“cure” refers to chemically crosslinking, such as by exposing to radiation in any form, heating, or allowing to undergo a chemical reaction that results in hardening or an increase in viscosity (e.g., under room temperature or heated conditions);

“microreplicated” means having a configuration of repeating, three-dimensional structures where at least two dimensions of the structures are microscopic;

“nanostructured” means characterized by topological features having respective dimensions on a nanometer scale (for example, between 1 nm and 500 nm);

“polymer” refers to a molecule having at least one repeating unit and can include copolymers;

“solvent” refers to a liquid capable of dissolving a solid, liquid, or gas, such as silicones, organic compounds, water, alcohols, ionic liquids, and supercritical fluids; and “patterned” means having a configuration of replicated, three-dimensional structures.

### DETAILED DESCRIPTION

Repeated use of reference characters in the specification and drawings is intended to represent the same or analogous features or elements of the disclosure. It is to be understood that numerous other modifications and embodiments can be devised by those skilled in the art and fall within the scope and spirit of the principles of the disclosure. The figures may not be drawn to scale.

The provided surfacing films can be useful in many functional and/or decorative applications. In one application, the surfacing films are primarily used to prevent erosion of a respective substrate. In another application, the surfacing films may be used to provide a frictional surface on a walking surface to prevent slips and falls. In another application, the surfacing films are disposed on an outer surface of an aircraft component to reduce drag while in flight. In still another application, the surfacing films are applied to interior automotive or architectural surfaces for aesthetic reasons.

A surfacing film according to one exemplary embodiment is designated by the numeral 100 and shown in FIG. 1. As shown, the surfacing film 100 has a plurality of discrete layers. These layers include, in the following order, a surface layer 102, an intermediate layer 104, a printed layer 106, a support layer 108, and an optional adhesive layer 110. The layers are described in more detail in respective sections below.

The surface layer 102, the top most layer of FIG. 1, has first and second major surfaces 112, 114. The surface layer 102 is shown here directly contacting the adjacent intermediate layer 104, to which it can be laminated or coated. In some embodiments, the surface layer 102 and the intermediate layer 104 can be coextruded layers.

The first major surface 112 represents an exposed major surface of the surfacing film 100, although it is to be understood that this surface could be temporarily covered by a liner or other protective film for purposes of packaging or storage.

Optionally and as shown, the first major surface 112 has a patterned surface, such as a microreplicated surface. In FIG. 1, the first major surface 112 is characterized by a plurality of elongated ridges 116. In the embodiment shown, the elongated ridges 116 have a triangular cross-section and are parallel with each other. Optionally, the elongated ridges 116 extend across the entirety of the major surface 112, from edge to edge. The ridges 116 are spaced apart from each other by capillary channels 118 to form a replicated “skip tooth” pattern in which the inter-ridge spacing is constant.

The microreplicated surface exemplified here has been shown to not only reduce frictional drag on primary aircraft structures when air flow is aligned with the channels, but also provide a frictional surface. Frictional surfaces can be useful when there is a need for the surfacing film to function as a surface for foot traffic. Certain applications require both friction and drag reduction, such as over-wing walkway films for commercial aircraft. Microreplicated surfaces can be especially advantageous when they improve wet friction by wicking moisture or oily substances from exposed surfaces.

Frictional performance is generally highest when opposing surfaces slide along directions perpendicular to the aforementioned channels. In some embodiments, it can be advantageous for at least some of the channels to intersect each other thereby providing enhancement in friction over a wider range of directions.

While not intended to be limiting, various other examples of useful geometries that may be present on the provided surfacing films are described in co-pending U.S. provisional patent application, Ser. No. 62/115,186 (Swanson et al.), along with U.S. Pat. No. 5,848,769 (Fronek et al.), U.S. Pat. No. 5,971,326 (Bechert), U.S. Pat. No. 8,668,166 (Rawlings et al.), and U.S. Patent Publication No. 2012/0080085 (Honeker et al.).

The surface layer 102 is comprised of a fluoropolymer, such that the first major surface 112 is a fluoropolymer surface. Fluoropolymers include fluoroelastomers and fluoroplastics. Advantageously, these polymers tend to have high thermal stability and usefulness at high temperatures, and extreme toughness and flexibility at very low temperatures. Many of these polymers are almost totally insoluble in a wide variety of organic solvents. See, for example F. W. Billmeyer, Textbook of Polymer Science, 3rd ed., pp. 398-403, John Wiley & Sons, New York (1984).

Useful fluoropolymers can be prepared from a variety of fluorinated and non-fluorinated monomers, including perfluorocycloalkene, ethylene ethane, vinyl fluoride (fluoroethylene), vinylidene fluoride (1,1-difluoroethylene), tetrafluoroethylene, chlorotrifluoroethylene, propylene, hexafluoropropylene, perfluoropropylvinylether, perfluoromethylvinylether, ethylene tetrafluoroethylene, poly(methyl methacrylate), and combinations thereof.

In some embodiments, the surface layer 102 is made from a homopolymer of poly(vinylidene fluoride). In some embodiments, the surface layer 102 is made from a copolymer of vinylidene fluoride and hexafluoropropylene. In some embodiments, the surface layer 102 is made from a copolymer of tetrafluoroethylene, hexafluoropropylene, and vinylidene fluoride, such as sold under the tradename “THV” from 3M Company, St. Paul, Minn. In some embodiments, the surface layer 102 can be made from a THV/polyurethane interpenetrated network, as described in U.S. Patent Publication No. 2016/0237298 (Jing et al.).

The surface layer 102 can have any suitable thickness in keeping with the intended application of the surfacing film 100. The thickness of the surface layer 102 can be from 4 micrometers to 1024 micrometers, from 75 micrometers to 500 micrometers, from 100 micrometers to 150 micrometers, or in some embodiments, less than, equal to, or more than 4 micrometers, 5, 6, 7, 8, 9, 10, 12, 14, 16, 18, 20, 25, 30, 35, 40, 45, 50, 60, 70, 80, 90, 100, 120, 140, 160, 180, 200, 250, 300, 350, 400, 450, 500, 550, 600, 650, 700, 750, 800, 850, 900, 950, 1000, or 1024 micrometers.

The intermediate layer 104 is independent from the surface layer 102 but may be made from any of the same compositions described with respect to the surface layer. The intermediate layer 104 can, for instance, be made from poly(vinylidene fluoride) or copolymer or blend thereof. The intermediate layer 104 can also, however, be made from a polymer or itself incorporate a polymer layer that has a lesser solvent or chemical resistance than the surface layer 102, such as a polyurethane, or a polyurethane film co-extruded with poly(vinylidene fluoride) or copolymer or blend thereof.

Referring again to FIG. 1, the intermediate layer 104 has a microreplicated surface akin to that of the surface layer 102. In the figure, the respective microreplicated surfaces of these neighboring layers are mutually aligned. In some cases, mutual alignment is achieved by uniformly depositing the surface layer 102 onto a pre-shaped intermediate layer 104 from the liquid phase. Such deposition could take place using any known process, such as a solution coating process.

Methods of microreplication that may be used to obtain the microreplicated surface of the intermediate layer 104 are described in U.S. Pat. No. 9,285,584 (Hebrink). Known methods include extrusion replication, embossing, and casting, followed by, if needed, curing.

In general, the extrusion replication procedure utilizes a tool that will impart the negative structure in the polymer surface. The tooling can be of a variety of forms and materials. Commonly the form of the tooling will either be a sheet, roll, belt or roll of surface structured film. The tooling is generally constructed of material that falls either into the category of metal or polymer but could potentially include ceramic or other suitable material. For metal tools, the metal is generally diamond-machined, embossed, knurled, sandblasted, etc. to form the surface structure. The structured polymer surface is generally formed by extrusion replication where a thermoplastic resin is extruded using standard extrusion equipment and fed through a die and into a nip with a machined metal tool roll and a rubber roll. The molten polymer is quenched while in contact with the tool surface which then releases from the tool roll and is wound on a roll.

Another procedure for making structured surfaces is to coat UV curable acrylate functional resins against a tool followed by removal of the cross-linked structured film from the tool.

Another procedure for making structured surfaces is to coat thermally curable urethane functional resins against a tool followed by removal of the cross-linked structured film from the tool. This polyurethane layer can be prepared from the condensation polymerization of a reaction mixture that comprises a polyol, a polyisocyanate, and a catalyst. The reaction mixture may also contain additional components which are not condensation polymerizable, and may contain at least one UV stabilizer.

Because the polyurethane polymers described in this disclosure are formed from the condensation reaction of a polyol and a polyisocyanate, they contain polyurethane linkages. The polyurethane polymers formed in this disclosure may contain only polyurethane linkages or they may contain other optional linkages such as polyurea linkages, polyester linkages, polyamide linkages, silicone linkages, acrylic linkages, and the like.

Any of a number of polyols may be used. Polyols are hydroxyl-functional materials that have at least two terminal hydroxyl groups and may be generally described by the structure HO—B—OH, where the B group may be an aliphatic group, an aromatic group, or a group containing a combination of aromatic and aliphatic groups, and may contain a variety of linkages or functional groups, including additional terminal hydroxyl groups. The structure HO—B—OH can be a diol or a hydroxyl-capped prepolymer such as a polyurethane, polyester, polyamide, silicone, acrylic, or polyurea prepolymer.

As another possibility, the surface layer 102 could be initially formed as a free-standing film which is later thermoformed or otherwise laminated onto the pre-formed intermediate layer 104. As yet another possibility, the surface layer 102 could be disposed onto the intermediate layer 104 as a flat film and subsequently embossed by pressing both films against a patterned surface, as described above.

The order in which the layers of the surfacing film 100 are assembled is not critical. Greater flexibility in manufacturing may be achieved, for example, if surface layer 102 and intermediate layer 104 are made separately from the remaining layers 106, 108, 110. The printed layer 106 and support layer 108 may be provided, for example, as a bilayer that is laminated to the adhesive layer 110, surface layer 102, and/or intermediate layer 104 in a continuous manufacturing process.

In some embodiments, the printed layer 106, support layer 108, and adhesive layer 110 are laminated collectively to the surface layer 102 and intermediate layer 104. In some embodiments, the printed layer 106, support layer 108, and adhesive layer 110 represent layers of a commercial graphic film, such as available from 3M Company, St. Paul, Minn.

The printed layer 106 enables the surfacing film 100 to communicate information, through alphanumeric text or graphic images, to an installer or end user. In these cases, it is preferable for the surface layer 102 and intermediate layer 104 to be transparent to allow graphic images to be easily observed through these layers. Content conveyed through the printed layer 106 can be ornamental or functional. Examples of such content include photographic images, alphanumeric characters, arrows and symbols, and/or visually aesthetic features.

If desired, the printed layer 106 can provide visual contrast with respect to its underlying support layer 108. Visual contrast may be achieved by incorporating into the printed layer 106 some amount of pigment or dye sufficient to suffuse the printed layer 106 with color. The support layer 108 optionally includes a pigment or dye to provide an opaque or semi-opaque background that provides visual contrast with the printed layer 106.

While not shown in FIG. 1, the printed layer 106 could also be a continuous layer extending across most of, or the entirety of, the major surfaces of the surfacing film 100. In this instance, it is also possible for the printed layer 106, despite being continuous, to provide contrast by including areas with different colors, patterns, or degrees of saturation.

The composition of the printed layer 106 is not particularly restricted. In some embodiments, the printed layer 106 is made from a thermoset polymer. The thermoset polymer can be cured using actinic radiation, such as ultraviolet (UV) or visible light. In one exemplary embodiment, the printed layer 106 is comprised of a polyurethane-based ink. Any of a number of solvent-based inks are also possible, which may be curable by actinic radiation. As another option, color can be imparted using a pigment mixed with one or more binders. Suitable binders can be derived from polyurethane and/or acrylic polymers.

The printed layer 106 can disposed on the support layer 108 using any known method, such as ink-jet printing, flexographic printing, contact printing, thermal transfer printing, and gravure coating. The printed layer 106 can be continuous or discontinuous.

Moreover, the printed layer 106 may be either single-layered or multi-layered. Each individual layer can be continuous or discontinuous. The layers can cover the same or different areas along the support layer 108. Moreover, a given layer can cover none of, partially cover, or fully cover, another layer. A given layer may be patterned, if desired.

Patterned layers may be in forms including, for example, lines, dots, squares, circles, and combinations thereof. Component layers of the printed layer 106 can be of uniform or varying thickness.

The printed layer 106 preferably has a thickness sufficient for it to provide visual contrast with itself or the support layer 108 as indicated above. Typical solvent based ink coatings can be 1 to 2 micrometers in thickness. Typical UV-cured ink printings can be 6 to 12 micrometers in thickness. Typical gravure printings can be approximately 5 micrometers in thickness, and optionally disposed on a metallized layer.

In general, the thickness of the printed layer 106 can be from 0.5 micrometers to 25 micrometers, from 1 micrometer to 12.5 micrometers, from 1 micrometer to 2 micrometers, or in some embodiments, less than, equal to, or more than 0.01 micrometers, 0.02, 0.03, 0.05, 0.07, 0.1, 0.15, 0.2, 0.5, 0.7, 1, 2, 3, 4, 5, 6, 7, 8, 9, 10, 12, 14, 16, 18, 20, 25, 30, 35, 40, 45, or 50 micrometers.

As further shown in FIG. 1, the support layer 108 is disposed between the printed layer 106 and adhesive layer 110. In cases where the printed layer 106 is relatively thin, the support layer 108 can help provide strength to the printed layer 106 for improved structural integrity and web handling in a manufacturing process.

The support layer 108 can include one or more polymeric layers. Particularly suitable polymers for the support layer 108 include polyurethane, polyacrylates and polymethacrylates such as poly(methyl methacrylate) and butyl acrylate, polycarbonates, and blends and copolymers thereof. In one embodiment, the support layer 108 is made from a block copolymer of poly(methyl methacrylate) and poly(butyl acrylate), such as available by Kuraray America Inc., Houston, Tex., under the trade designation KURARITY.

In some embodiments, the support layer 108 is a printable layer. In some embodiments, the printable layer is an ink-receptive layer capable of receiving and permanently retaining an ink. While not shown explicitly in FIG. 1, the support layer 108 may itself be comprised of two or more layers. For example, the support layer 108 may include two or more polymeric layers.

The support layer 108 may include one or more non-polymeric layers. The support layer 108 may be comprised of a polymeric layer that is at least partially metallized. The metallized surface could extend across some of all of a major surface of the support layer 108 that faces the printed layer 106. Various processes and technologies may be employed to obtain a metallized surface. Metallization processes include vapor deposition, vacuum metallization, lamination, calendaring, sputtering, electrolytic plating, evaporating, and flash coating.

The support layer 108 can have any thickness sufficient to provide integrity during its handling and printing. The thickness of the support layer 108 can be from 10 micrometers to 350 micrometers, from 11 micrometers to 170 micrometers, from 12.5 micrometers to 80 micrometers, or in some embodiments, less than, equal to, or more than 10 micrometers, 12, 14, 16, 18, 20, 25, 30, 35, 40, 45, 50, 60, 70, 80, 90, 100, 120, 140, 160, 180, 200, 220, 240, 260, 280, 300, 320, 340, or 350 micrometers.

Optionally, the surfacing film 100 further includes the adhesive layer 110. The adhesive layer 110, in preferred embodiments, is a pressure sensitive adhesive layer. The pressure sensitive adhesive layer can be normally tacky at ambient conditions. Suitable pressure sensitive adhesives can be based on polyacrylates, synthetic and natural rubbers, polybutadiene and copolymers or polyisoprenes and copolymers. Silicone based adhesives such as polydimethylsiloxane and polymethylphenylsiloxane may also be used. Preferred pressure sensitive adhesives include polyacrylate-based adhesives, which can display advantageous properties as high degrees of clarity, UV-stability and aging resistance. Polyacrylate adhesives suitable for protective film applications are described, for example, in U.S. Pat. No. 4,418,120 (Kealy et al.); RE24,906 (Ulrich); U.S. Pat. No. 4,619,867 (Charbonneau et al.); U.S. Pat. No. 4,835,217 (Haskett et al.); and International Patent Publication No. WO 87/00189 (Bonk et al.).

Preferably, a polyacrylate pressure sensitive adhesive contains a crosslinkable copolymer of a C4-C12 alkylacrylate and an acrylic acid. The adhesive can be used with or without a crosslinker. Useful crosslinking reactions include chemical crosslinking and ionic crosslinking. The chemical crosslinker could include polyaziridine and/or bisamide and the ionic crosslinker may include metal ions of aluminum, zinc, zirconium, or a mixture thereof. A mixture of chemical crosslinker and ionic crosslinker can also be used. In some embodiments, the polyacrylate pressure sensitive adhesive includes a tackifier such as rosin ester.

To adjust properties of the adhesive, the adhesive layer 110 may contain additives such as ground glass, titanium dioxide, silica, glass beads, waxes, tackifiers, low molecular weight thermoplastics, oligomeric species, plasticizers, pigments, metallic flakes and metallic powders as long as they are provided in an amount that does not unduly degrade the quality of the adhesive bond to the surface.

The layers of the surfacing film 100 depicted in FIG. 1 need not be exclusive. One or more additional layers may be present between any of the depicted layers or on either major surface of the surfacing film 100. For example, a release liner can optionally extend across and contact the adhesive layer 110 to assist in handling and storage of the surfacing film 100.

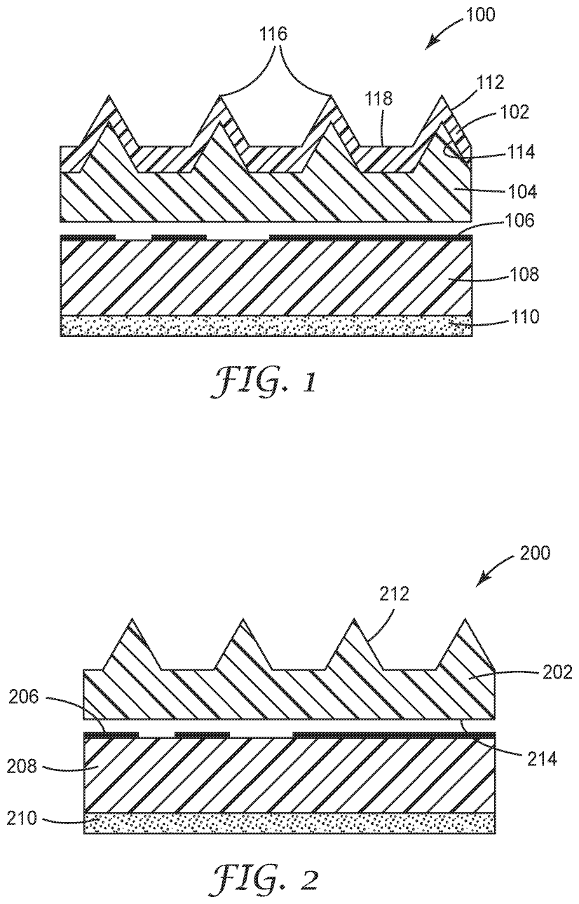

FIG. 2 shows a surfacing film 200 according to a different embodiment in which the printed layer directly contacts a unitary layer exposed at the surface of the film. As shown, the surfacing film 200 includes a surface layer 202 having an outward-facing major surface 212 that is a patterned surface and an inward-facing second major surface 214 that is planar. Like the surface layer 102 in the prior embodiment, the surface layer 202 is made from a fluoropolymer or at least has a fluoropolymer surface.

The surface layer 202 is coupled to the three underlying layers shown in FIG. 2—a printed layer 206, support layer 208, and adhesive layer 210. The configurations and compositions of these underlying layers are similar to those already described with respect to the surfacing film 100 of FIG. 1 and need not be repeated here.

Achieving strong adhesion to a fluoropolymer surface is a known technical challenge. The adhesion between the surface layer 202 and the printed layer 206 (and/or support layer 208) can be enhanced by providing the second major surface 214 of the surface layer 202 with a nanostructured surface.

In some embodiments, the nanostructured surface has an anisotropic nanostructure, in which the topological features have a height to width (that is, average width) ratio of at least 1.5:1, at least 2:1, at least 3:1, at least 4:1, or at least 5:1.

In some embodiments, the nanostructured surface enables some degree of permeation or interpenetration of the printed layer 206 and/or support layer 208 into the nanostructured surface where these layers contact each other. The nanostructured surface can further include undercut features that provide mechanical retention along the interface between the surface layer 202 and the underlying printed layer 206/support layer 208. By causing one layer to be at least partially embedded in the other, or mutually interlocked, the nanostructured surface enables the surfacing film 200 to resist de-lamination.

Plasma reactive ion etching is one way to provide a nanostructured surface on the fluoropolymer surface of the surface layer 202. Plasma is a partially ionized gaseous or fluid state of matter containing electrons, ions, neutral molecules, and free radicals.

Reactive ion etching can be carried out using any of a number of methods. One exemplary method uses a rotatable cylindrical electrode known as a drum electrode and a grounded counter-electrode within a vacuum vessel. The counter-electrode can be comprised of the vacuum vessel itself. Gas comprising an etchant is fed into the vacuum vessel, and plasma is ignited and sustained between the drum electrode and the grounded counter-electrode. The conditions are selected so that sufficient ion bombardment is directed perpendicular to the circumference of the drum. A continuous substrate comprising a nanoscale mask can then be wrapped around the circumference of the drum and the matrix can be etched in the direction normal to the plane of the article. The exposure time of the article can be controlled to obtain a predetermined etch depth of the resulting nanostructure.

Further improvement to adhesion between a fluoropolymer and a nonfluorinated polymer layer, such as the printed layer 206 and/or support layer 208, can be achieved by surface treatment followed by applying a layer of a second material such as a thermoplastic polyamide, such as described in U.S. Pat. No. 6,074,719 (Fukushi et al.).

Advantageously, the presence of a nanostructured surface on the second major surface 214 enables a fluoropolymer surface layer 202 to be securely coupled to the underlying printed layer 206 and support layer 208 without need for an adhesive. The absence of an interlayer adhesive in turn enables a surfacing film 200 that can be made thinner and simpler in construction.

FIG. 3 shows a surfacing film 300 according to another embodiment that, like surfacing film 200, has a surface layer 302 made in part or in whole from a fluoropolymer, printed layer 306, support layer 308, and adhesive layer 310. Unlike the prior surfacing film 200, the surfacing film 300 further includes a tie layer 303 that assists in bonding the surface layer 302 to the underlying printed layer 306 and support layer 308.

In some embodiments, the surface layer 302 and tie layer 303 are coextruded layers. Coextruding the tie layer 303 and the surface layer 302 from the molten state can allow for some degree of polymer chain entanglement at the interface between layers and improve interlayer adhesion.

The tie layer 303 can be made from any suitable polymer. In one preferred embodiment, the tie layer 303 is made from a polyurethane. In another preferred embodiment, the tie layer 303 comprises a polyurethane and poly(vinylidene fluoride). The tie layer 303 could be blended, copolymerized with, or coextruded from two or more different polymers. For example, in one embodiment, the tie layer 303 is a polyurethane film coextruded with poly(vinylidene fluoride), with the polyurethane side facing the underlying printed layer 306 and support layer 308.

The tie layer 303 need not be polymeric. For example, useful tie layers can be made from sintered nanosilica, as described in U.S. Patent Publication 2013/0040126 (Pett, et al.).

The tie layer 303 has a chemical composition that enables the underlying printed layer 306 and support layer 308 to be heat laminated to it without need for a nanostructured surface or any other surface modification.

The tie layer 303 can have any suitable thickness but can be made relatively thin. The thickness of the tie layer 303 can be from 0.1 micrometers to 350 micrometers, from 1 micrometer to 160 micrometers, from 12.5 micrometers to 80 micrometers, or in some embodiments, less than, equal to, or more than 0.1 micrometers, 0.2, 0.5, 0.7, 1, 2, 4, 6, 8, 10, 12, 14, 16, 18, 20, 25, 30, 35, 40, 45, 50, 60, 70, 80, 90, 100, 120, 140, 160, 180, 200, 220, 240, 260, 280, 300, 320, 340, or 350 micrometers.

Aspects of the remaining layers of the surfacing film 300 are analogous to those already described.

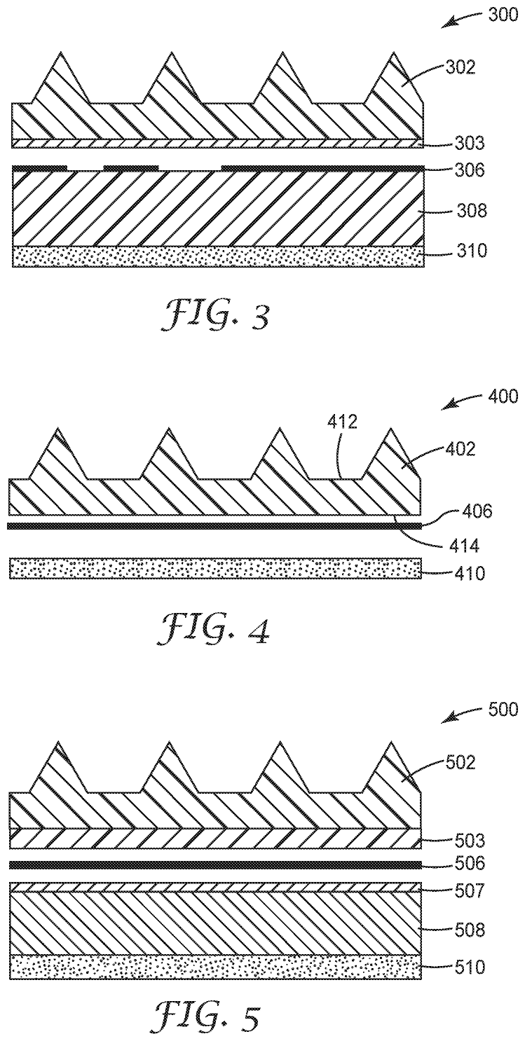

FIG. 4 shows a surfacing film 400 according to yet another embodiment in which neither a tie layer nor support layer are present. The surfacing film 400 can have a surface layer 402 having first and second major surfaces 412, 414, with characteristics similar to the surface layer 202 of FIG. 2. The surface layer 202 can be either a fluoropolymer layer or a polymeric layer having a fluoropolymer outer surface.

The second major surface 414 is provided with a nanostructured surface and the printed layer 406 is disposed directly to the underside of the surface layer 402. The nanostructured surface, optionally provided by plasma reactive ion etching as described previously, can enhance interlayer adhesion thereby helping to secure the printed layer 406 and surface layer 402 to each other.

The adhesive layer 410 extends across and directly contacts the printed layer 406. In FIG. 4, the printed layer 406 has been made continuous to obscure the adhesive layer 410 from view after the surfacing film 400 has been applied to a substrate.

FIG. 5 shows a surfacing film 500 according to yet another embodiment. Like previous embodiments, the surfacing film 500 includes a surface layer 502, printed layer 506, support layer 508, and adhesive layer 510. In this instance, the printed layer 506 is a continuous layer, although the printed layer 506 could also be made discontinuous.

Disposed between the printed layer 506 and the surface layer 502 is a tie layer 503. The tie layer 503 is made from a composition that is chemically compatible with both the surface layer 502 and the printed layer 506, enabling a strong adhesive bond with each of these neighboring layers. The compositions of these layers are not particularly restricted. In a preferred embodiment, the surface layer 502 is a fluoropolymer layer, the tie layer 503 is a copolymer of poly(vinylidene fluoride) and poly(methyl methacrylate), and the printed layer 106 is a pigmented polyurethane-based ink.

In another embodiment, the fluoropolymer layer is comprised of THV, a fluorinated copolymer made from hexafluoropropylene, tetrafluoroethylene, and ethylene monomers (collectively, HTE) or copolymers of tetrafluoroethylene and ethylene, while the tie layer is comprised of a polyurethane.

The underlying layers include a metallized layer 507, support layer 508, and adhesive layer 510. Compositional and functional aspects of each of these layers have been reviewed previously. In this multilayered construction, the printed layer 506 may be first disposed on the tie layer 503 prior to laminating it to the metallized support layer and any other underlying layers. As an alternative, the printed layer 506 may be first disposed on the metallized layer 507 and subsequently laminated to the surface layer 502 and tie layer 503.

Advantageously, the provided surfacing films can resist spontaneous delamination from its substrate even when subjected to a wide range of harsh environmental conditions, including exposure to rain, sleet, sea water, cleaning chemicals, and hydraulic fluids.

In the event that the provided surfacing film does delaminate from its substrate, it can be strongly preferred for the surfacing film to fragment into a multiplicity of pieces, rather than delaminate in a single piece. This quality can be especially desirable for surfacing films that are used on aircraft, because large pieces of surfacing film, once fully detached, are sufficiently massive to interfere with the operation of fins, stabilizers, and other moving parts of the aircraft.

The behavior of the surfacing film upon delamination correlates with measurable test data, such as delamination peel strength and tensile strength. Where delamination tends to occur at the interface between the adhesive layer and the substrate, it can be preferred for the delamination peel strength of the surfacing film from the substrate is greater than the tensile strength of the surfacing film alone, based on the 180° Peel Test (described in the Examples section below).

Depending on the composition of the surface layer, delamination may instead tend to occur at the interface between the surface film and its underlying layers. In this case, it is preferable that the delamination peel strength of the surface layer from the underlying layers is greater than the tensile strength of the surface layer alone, based on the 180° Peel Test (described in the Examples section below).

It was also discovered that the peel behavior of the provided surfacing films is affected by the relative glass transition temperatures of neighboring layers within the surfacing film. Empirical studies have shown that the surfacing film is more likely to fragment upon delamination when the glass transition temperature of the surface layer significantly exceeds the glass transition temperature of its neighboring layer. As has been demonstrated, the neighboring layer may be a tie layer, a coextruded polyurethane layer, a printed layer, support layer, or any combination thereof.

In the film constructions of FIGS. 1-5, one or more layers may include additional fillers and other additives. Such additives may be decorative or utilitarian in nature.

One or more layers of the surfacing film, for example, may contain for example an UV absorber. By directly absorbing UV light, these chemical compounds can reduce the degree of photoinduced degradation. UV absorbers can effectively absorb light at wavelengths less than about 400 nm. UV absorbers are typically included in the UV absorbing layer in an amount that absorb at least 70 percent, typically 80 percent, more typically greater than 90 percent, or even greater than 99 percent of incident light in a wavelength region from 180 to 400 nm.

Typical UV-absorbing layer thicknesses are from 10 to 500 micrometers, although thinner and thicker UV-absorbing layers may also be used. Typically, the UV-absorber is present in the UV-absorbing layer in an amount of from 2 to 20 percent by weight, but lesser and greater levels may also be used.

An exemplary UV-absorber can be a benzotriazole compound, 5-trifluoromethyl-2-(2-hydroxy-3-alpha-cumyl-5-tert-octylphenyl)-2H-benzo-triazole. Other exemplary benzotriazoles include 2-(2-hydroxy-3,5-di-alpha-cumylphenyl)-2H-benzotriazole, 5-chloro-2-(2-hydroxy-3-tert-butyl-5-methylphenyl)-2H-benzothiazole, 5-chloro-2-(2-hydroxy-3,5-di-tert-butylphenyl)-2H-benzotriazole, 2-(2-hydroxy-3,5-di-tert-amylphenyl)-2H-benzotriazole, 2-(2-hydroxy-3-alpha-cumyl-5-tert-octylphenyl)-2H-benzotriazole, 2-(3 -tert-butyl-2-hydroxy-5-methylphenyl)-5-chloro-2H-benzotriazole. Additional exemplary UV-absorbers include 2(-4,6-diphenyl-1-3,5-triazin-2-yl)-5-hexyloxy-phenol, and those available from BASF Chemicals Corp. as TINUVIN 1577, TINUVIN 1600, and TINUVIN 900.

UV absorbers are broadly described in U.S. Pat. No. 5,450,235 (Smith et al.), U.S. Pat. No. 9,523,516 (Hebrink et al.) and U.S. Pat. No. 9,285,584 (Hebrink), and U.S. Patent Publication No. 2014/0009824 (Meitz et al.).

In some embodiments, it is desirable to use red shifted UV absorbers (RUVA) which absorb at least 70% (in some embodiments, at least 80%, particularly preferably greater than 90% of the UV light in the wavelength region from 180 nm to 400 nm. Typically, it is desirable if the RUVA is highly soluble in polymers, highly absorptive, photo-permanent and thermally stable in the temperature range from 200° C. to 300° C. for extrusion process to form the protective layer. The RUVA can also be highly suitable if they can be copolymerizable with monomers to form protective coating layer by UV curing, gamma ray curing, e-beam curing, or thermal curing processes.

RUVAs typically have enhanced spectral coverage in the long-wave UV region, enabling it to block the high wavelength UV light that can cause yellowing in polyesters. Typical UV protective layers have thicknesses in a range from 13 micrometers to 380 micrometers (0.5 mil to 15 mil) with a RUVA loading level of 2-10%). Other preferred benzotriazoles include 2-(2-hydroxy-3,5-di-alpha-cumylphehyl)-2H-benzotriazole, 5-chloro-2-(2-hydroxy-3-tert-butyl-5-methylphenyl)-2H-benzothiazole, 5-chloro-2-(2-hydroxy-3,5-di-tert-butylphenyl)-2H-benzotriazole, 2-(2-hydroxy-3,5-di-tert-amylphenyl)-2H-benzotriazole, 2-(2-hydroxy-3-alpha-cumyl-5-tert-octylphenyl)-2H-benzotriazole, 2(3-tert-butyl-2-hydroxy-5-methylphenyl)-5-chloro-2Hbenzotriazole. Further preferred RUVA includes 2(-4,6-diphenyl-1-3,5-triazin-2-yl)-5-hekyloxy-phenol. Other exemplary UV absorbers include those available from Ciba Specialty Chemicals Corporation, Tarrytown, N.Y., under the trade designation TINUVIN 1577, TINUVIN 1600, TINUVIN 900, and TINUVIN 777.

Preferred UV absorbers include biphenyltriazines available from Sukano as masterbatch concentrates under the trade designations PMMA(TA11-10 MB01), PC(TA28-09 MB02), and PET(TA07-07 MB01).

One or more layers of the surfacing film may contain a hindered amine light stabilizer (HALS). HALS, when incorporated into a polymer or copolymer, can also help the polymer or copolymer resist adverse effects of actinic radiation (e.g., visible and UV light) by slowing down photochemically initiated degradation reactions.

Exemplary HALS include those available from BASF Chemicals Corp. under the trade designations CHIMASSORB 944 and TINUVIN 123. Exemplary antioxidants include those available as IRGANOX 1010 and ULTRANOX 626 from BASF Chemicals Corp. Further details concerning HALS are described in U.S. Pat. No. 9,523,516 (Hebrink et al.) and U.S. Pat. No 9,285,584 (Hebrink), and International Patent Publication No. WO 2016/105974 (Klun et al.).

While not intended to be exhaustive, further embodiments of the provided surfacing films and methods thereof are enumerated as follows:
1. A surfacing film comprising: a surface layer having opposed first and second major surfaces, the first major surface comprising a fluoropolymer surface and the second major surface comprising a nanostructured surface; and a printed layer disposed on the second major surface and at least partially embedded in the nanostructured surface.
2. The surfacing film of embodiment 1, wherein the printed layer comprises a thermoset polymer.
3. The surfacing film of embodiment 1 or 2, wherein the nanostructured surface comprises a plasma reactive ion etched surface.
4. The surfacing film of any one of embodiments 1-3, further comprising an adhesive layer extending across at least a portion of the printed layer.
5. The surfacing film of embodiment 4, wherein the adhesive layer is a pressure-sensitive adhesive layer.
6. The surfacing film of embodiment 4 or 5, further comprising a support layer disposed between the adhesive layer and the printed layer.
7. The surfacing film of embodiment 6, wherein the support layer comprises a polyurethane, polyacrylate, polymethacrylate, polycarbonate, or a blend or copolymer thereof.
8. The surfacing film of embodiment 7, wherein the support layer comprises a block copolymer comprising poly(methyl methacrylate) and poly(butyl acrylate).
9. The surfacing film of any one of embodiments 6-8, wherein the printed layer is discontinuous.
10. The surfacing film of any one of embodiments 6-9, wherein the support layer is pigmented.
11. The surfacing film of any one of embodiments 6-10, wherein the support layer is an ink-receptive layer.
12. The surfacing film of any one of embodiments 1-11, wherein the first major surface has a microreplicated surface.
13. The surfacing film of embodiment 12, wherein the microreplicated surface comprises a plurality of ridges defining capillary channels.
14. A surfacing film comprising: a surface layer having opposed first and second major surfaces, wherein the first major surface comprises a fluoropolymer surface; and a microreplicated intermediate layer in contact with the second major surface, wherein the fluoropolymer surface has a microreplicated surface at least partially shaped by the microreplicated intermediate layer.
15. The surfacing film of embodiment 14, wherein the microreplicated surface comprises a plurality of ridges defining capillary channels.
16. The surfacing film of embodiment 14 or 15, wherein the microreplicated intermediate layer comprises poly(vinylidene fluoride).
17. The surfacing film of embodiment 16, wherein the microreplicated intermediate layer comprises a copolymer or blend of poly(vinylidene fluoride) and poly(methyl methacrylate).
18. The surfacing film of embodiment 14 or 15, wherein the microreplicated intermediate layer comprises a polyurethane.
19. The surfacing film of embodiment 18, wherein the microreplicated intermediate layer comprises a polyurethane film coextruded with poly(vinylidene fluoride).
20. The surfacing film of any one of embodiments 14-19, further comprising a printed layer disposed on the second major surface, wherein the printed layer is discontinuous.
21. A surfacing film comprising: a surface layer having opposed first and second major surfaces, the first major surface comprising a fluoropolymer surface; a tie layer underlying the surface layer, wherein the surface layer and the tie layer are coextruded layers; and a printed layer disposed on the tie layer.
22. The surfacing film of embodiment 21, wherein the tie layer comprises poly(methyl methacrylate).
23. The surfacing film of embodiment 22, wherein the tie layer comprises a block copolymer comprising poly(methyl methacrylate) and poly(butyl acrylate).
24. The surfacing film of any one of embodiments 21-23, wherein the tie layer has a thickness of from 0.1 micrometers to 350 micrometers.
25. The surfacing film of embodiment 24, wherein the tie layer has a thickness of from 1 micrometer to 160 micrometers.
26. The surfacing film of embodiment 25, wherein the tie layer has a thickness of from 12.5 micrometers to 80 micrometers.
27. The surfacing film of any one of embodiments 21-26, wherein the printed layer is discontinuous.
28. The surfacing film of any one of embodiments 20-27, further comprising a support layer disposed on at least a portion of the printed layer.
29. The surfacing film of embodiment 28, wherein the support layer comprises polyurethane.
30. The surfacing film of embodiment 28, wherein the support layer comprises poly(methyl methacrylate).
31. The surfacing film of embodiment 30, wherein the support layer comprises a block copolymer comprising poly(methyl methacrylate) and poly(butyl acrylate).
32. The surfacing film of any one of embodiments 28-31, wherein the support layer is pigmented.
33. The surfacing film of any one of embodiments 28-32, wherein the support layer is an ink-receptive layer.
34. The surfacing film of any one of embodiments 28-33, wherein the support layer has a thickness of from 10 micrometers to 350 micrometers.
35. The surfacing film of embodiment 34, wherein the support layer has a thickness of from 10 micrometers to 170 micrometers.
36. The surfacing film of embodiment 35, wherein the support layer has a thickness of from 12.5 micrometers to 80 micrometers.
37. The surfacing film of any one of embodiments 14-36, further comprising an adhesive layer extending across the second major surface of the surface layer.
38. The surfacing film of embodiment 37, wherein the adhesive layer is a pressure-sensitive adhesive layer.
39. A surfacing film comprising: a surface layer having opposed first and second major surfaces; and an adhesive layer extending across the second major surface, wherein the first major surface comprises a fluoropolymer surface comprises a microreplicated surface and wherein delamination peel strength of the surface layer from the remaining layers is greater than the tensile strength of the surface layer based on the 180° Peel Test.
40. The surfacing film of embodiment 39, further comprising a tie layer disposed between the surface layer and the adhesive layer.
41. The surfacing film of embodiment 40, wherein the tie layer comprises a polyurethane layer.
42. The surfacing film of embodiment 40 or 41, wherein the tie layer has a thickness of from 0.1 micrometers to 350 micrometers.
43. The surfacing film of embodiment 42, wherein the tie layer has a thickness of from 1 micrometer to 160 micrometers.
44. The surfacing film of embodiment 43, wherein the tie layer has a thickness of from 12.5 micrometers to 80 micrometers.
45. The surfacing film of any one of embodiments 1-44, wherein delamination peel strength of the surface layer from the remaining layers exceeds the tensile strength of the surface layer based on the 180° Peel Test.
46. The surfacing film of any one of embodiments 1-45, wherein the fluoropolymer surface comprises poly(vinylidene fluoride) homopolymer.
47. The surfacing film of any one of embodiments 1-45, wherein the fluoropolymer surface comprises a copolymer of vinylidene fluoride and hexafluoropropylene.
48. The surfacing film of any one of embodiments 1-45, wherein the fluoropolymer surface comprises a copolymer of tetrafluoroethylene, hexafluoropropylene, and vinylidene fluoride.
49. The surfacing film of any one of embodiments 1-45, wherein the fluoropolymer surface comprises a copolymer of hexafluoropropylene, tetrafluoroethylene, and ethylene.
50. The surfacing film of any one of embodiments 1-49, wherein the surface layer has a thickness of from 4 micrometers to 1024 micrometers.
51. The surfacing film of embodiment 50, wherein the surface layer has a thickness of from 75 micrometers to 500 micrometers.
52. The surfacing film of embodiment 51, wherein the surface layer has a thickness of from 100 micrometers to 150 micrometers.
53. The surfacing film of any one of embodiments 1-52, wherein the fluoropolymer surface comprises a plurality of ridges arranged in a replicated skip tooth pattern.
54. The surfacing film of any one of embodiments 1-13 and 20-36, wherein the printed layer has a thickness of from 0.5 micrometers to 50 micrometers.
55. The surfacing film of embodiment 54, wherein the printed layer has a thickness of from 1 micrometer to 25 micrometers.
56. The surfacing film of embodiment 55, wherein the printed layer has a thickness of from 1 micrometer to 6 micrometers.
57. The surfacing film of any one of embodiments 1-13, 20-36 and 54-56, wherein the printed layer comprises a polyurethane-based ink.
58. The surfacing film of any one of embodiments 1-8, 10-13, 21-26, 28-38, and 54-57, wherein the printed layer is a continuous layer and gravure-coated.
59. The surfacing film of any one of embodiments 1-58, wherein the glass transition temperature of the surface layer exceeds the glass transition temperature of its neighboring layer.
60. The surfacing film of any one of embodiments 1-59, wherein one or more layers of the surfacing film comprises an ultraviolet absorber.
61. The surfacing film of any one of embodiments 1-60, wherein one or more layers of the surfacing film comprises a hindered amine light stabilizer.
62. The surfacing film of any one of embodiments 6-11 and 28-36, wherein the support layer has a major surface facing the printed layer that is at least partially metallized.
63. The surfacing film of any one of embodiments 1-62, wherein the first major surface has a microreplicated surface comprised of a plurality of ridges defining channels, and further wherein at least some of the channels intersect each other.
64. A method of using the surfacing film of any one of embodiments 1-63, comprising applying the surfacing film to an outer surface of an aircraft component to enhance friction.
65. A method of making a surfacing film, the method comprising: disposing a printed layer on a support layer to provide a bilayer; and laminating the bilayer to a surface layer having opposing first and second major surfaces, wherein the first major surface comprises a fluoropolymer surface and the second major surface has a nanostructured surface and is in contact with the printed layer.
66. The method of making the surfacing film of embodiment 65, wherein the step of laminating the bilayer to the surface layer does not use an adhesive.

Objects and advantages of this disclosure are further illustrated by the following non-limiting examples, but the particular materials and amounts thereof recited in these examples, as well as other conditions and details, should not be construed to unduly limit this disclosure.

### EXAMPLES

Unless otherwise noted, all parts, percentages, ratios, etc. in the Examples and the rest of the specification are by weight.

TABLE 1
MATERIALS

| Designation | Description | Source |
|---|---|---|
| PVDF 6008 | A fluoropolymer made from vinylidene | 3M Co., St. Paul, MN |
| | fluoride (“VDF”) monomers, available | |
| | under the trade designation 3M | |
| | DYNEON PVDF 6008 | |
| CoPVDF 11010 | A fluorinated copolymer made from | 3M Co., St. Paul, MN |
| | VDF and hexafluoropropylene (“HFP”) | |
| | monomers, available under the trade | |
| | designation 3M DYNEON CoPVDF | |
| | 11010 | |
| THV 500 | A fluorinated copolymer made from | 3M Co., St. Paul, MN |
| | tetrafluoroethylene (“TFE”), HFP, and | |
| | VDF monomers, available under the | |
| | trade designation 3M DYNEON | |
| | FLUOROPLASTIC THV 500GZ | |
| HTE 1705 | A fluorinated copolymer made from | 3M Co., St. Paul, MN |
| | HFP, TFE, and ethylene monomers, | |
| | available under the trade designation 3M | |
| | DYNEON HTE 1705 | |
| TEXIN 285 | A thermoplastic polyurethane, available | Lubrizol Corp., |
| | under the trade designation TEXIN 285 | Wickliffe, OH |
| PP | A polypropylene homopolymer | Atofina Chemicals, Inc., |
| | | Philadelphia, PA |
| ETFE | A fluorinated copolymer made from TFE | 3M Co., St. Paul, MN |
| | and ethylene, available under the trade | |
| | designation 3M DYNEON ETFE | |
| PU TAPE 8671 | A white, printable polyurethane (“PU”) | 3M Co., St. Paul, MN |
| | tape (including a 12 mil (about 305 | |
| | micrometer) polyurethane layer and a 2 | |
| | mil (about 51 micrometer) pressure | |
| | sensitive adhesive layer), available under | |
| | the trade designation 3M | |
| | POLYURETHANE PROTECTIVE | |
| | TAPE 8671 GW | |
| PU TAPE 8673 | A clear, printable polyurethane tape | 3M Co., St. Paul, MN |
| | (including a 12 mil (about 305 | |
| | micrometer) polyurethane layer and a 2 | |
| | mil (about 51 micrometer) pressure | |
| | sensitive adhesive layer), available under | |
| | the trade designation 3M | |
| | POLYURETHANE PROTECTIVE | |
| | TAPE 8673 | |
| PU TAPE 8674 | A clear, printable polyurethane tape | 3M Co., St. Paul, MN |
| | (including a 6 mil (about 152 | |
| | micrometer) polyurethane layer and a 2 | |
| | mil (about 51 micrometer) pressure | |
| | sensitive adhesive layer), available under | |
| | the trade designation 3M | |
| | POLYURETHANE PROTECTIVE | |
| | TAPE 8674 | |
| 9802 UV INK | A UV curable ink available under the | 3M Co., St. Paul, MN |
| | trade designation 3M 9802 OPAQUE | |
| | BLACK SCREEN PRINTING UV INK | |
| SKYDROL LD-4 | A fire resistant hydraulic fluid, available | Eastman Chemical |
| | under the trade designation SKYDROL | Companies, Kingsport, |
| | LD-4 | TN |

### Test Methods

### 180-DEGREE PEEL TEST

The 180-DEGREE PEEL TEST was performed according to ASTM D1876-08. Peel tests were performed at temperatures of +10° C., 0° C., −10° C., −20° C., −30° C., and −40° C., using a temperature equilibration time of 5 minutes prior to conducting the peel measurements on an INSTRON instrument. Test samples were cut to 1 inch (2.5 cm) wide by 6 inch (15 cm) long strips. The tests were carried out using an INSTRON instrument, for a 180 degree peel. The peel test values were for the separation between the cover layer and the printed support layer (e.g., 3M 8671) of test samples, and were reported as pound-force per inch (lbs/in; values were also converted to Newtons per cm (N/cm) by multiplying lbs/in value by 1.75 (using 1 lb/in=1.75 N/cm)).

### Method for Nanostructure Creation by Reactive Ion Etching (Plasma Treatment):

The nanostructures of this invention were generated out by using a homebuilt plasma treatment system described in detail in U.S. Pat. No. 5,888,594 (David et al.), with some modifications. The width of the drum electrode was increased to 42.5 inches (108 cm) and the separation between the two compartments within the plasma system was removed so that all the pumping was carried out by means of the turbo-molecular pump and thus operating at a process pressure of around 10 mTorr (about 1.3 Pa). A roll of the polymeric film to be treated was mounted within the chamber, the film wrapped around the drum electrode and secured to the take up roll on the opposite side of the drum. The unwind tension and take-up tension were both maintained at 6 pounds (10 N) and 14 pounds (10 N), respectively. The chamber door was closed and the chamber was pumped down to a base pressure of 5×10⁻⁴ torr (about 0.07 Pa). For the plasma treatment, hexamethyldisiloxane (HMDSO) and oxygen were introduced at a flow rate of 60 standard cm³/min and 750 standard cm³/min respectively, and the operating pressure was nominally at 9 mTorr (about 1.2 Pa). Plasma was turned on at a power of 7500 watts by applying RF power to the drum and the drum rotation was initiated so that the film was transported at a speed of 10 feet/min (about 3.0 m/min.). The run was continued until the entire length of the film on the roll was completed.

After the entire roll of polymeric film was treated in the above manner, the RF power was disabled, oxygen flow stopped, chamber vented to the atmosphere, and the roll taken out of the plasma system for further processing.

### Comparative Example 1

Painted PU TAPE 8671 tape (painted with 9802 UV INK), thermally laminated onto a 12-mil (305-micrometer) thick clear, flat PU tape (PU TAPE 8673, without adhesive).

### Comparative Example 2

Comparative Example 1 with an added 1-mil (25-micrometer) thick flat THV500 film (fluoropolymer film) placed on top of a portion of the Comparative Example 1 layer.

### Example 1

### Microreplicated Film made Via Extrusion of PVDF 6008

PVDF 6008 was extruded using a 25 mm twin screw extruder at 18.2 kg/hr (40 pph) through a flat film die onto a patterned casting roll. The surface structure on the polymeric film was formed by contacting the outer major surface of the first layer of the polymeric film with a patterned casting roll at 82° C. and using a rubber nip roll applying a nip force of 5.965 kg per cm (33 pounds per lineal inch) of film width and a line speed of 5.5 meters per minute (18 feet per minute). Patterned casting roll targeted a “skip tooth” pattern, with 80 micrometer tall linear prism features having an 80 micrometer base and a peak to peak spacing of 150. The included peak angle on the microreplicated features of the casting roll was 53 degrees. Extrusion replicated PVDF 6008 made using this process and patterned casting roll had rounded tips with a peak to valley height of 46 micrometers.

### Example 2

### Microreplicated Film made Via Extrusion of PVDF 6008, Plus Reactive Ion Etching Treatment

The microreplicated film of Example 1 was treated with the reactive ion etching treatment described above, on the major surface opposite the microreplicated surface.

### Example 3

### Microreplicated Film made Via Extrusion of CoPVDF 11010

CoPVDF 11010 was extruded using a 25 mm twin screw extruder at 18.2 kg/hr (40 pph) through a flat film die onto a patterned casting roll. The surface structure on the polymeric film was formed by contacting the outer major surface of the first layer of the polymeric film with a patterned casting roll at 82° C. and using a rubber nip roll applying a nip force of 5.965 kg per cm (33 pounds per lineal inch) of film width and a line speed of 5.5 meters per minute (18 feet per minute). Patterned casting roll targeted a “skip tooth” pattern, with 80 micrometer tall linear prism features having an 80 micrometer base and spaced apart by 150 micrometers. The included peak angle on the microreplicated features was 53 degrees. Extrusion replicated CoPVDF 11010 made using this process and patterned casting roll had rounded tips with a peak to valley height of 46 micrometers, as measured by confocal microscopy.

### Example 4

### Microreplicated Film made Via Extrusion of CoPVDF 11010, Plus Reactive Ion Etching Treatment

The microreplicated film of Example 3 was treated with the reactive ion etching treatment described above, on the major surface opposite the microreplicated surface.

### Example 5

### Microreplicated Multilayer Film made Via Coextrusion of CoPVDF 11010, TEXIN 285, and PP

A multilayer extrusion replicated polymeric film was made using a 3 layer multi-manifold die to coextrude a first layer of PVDF 11010, a second layer of a thermoplastic polyurethane TEXIN 285, and a third layer of a homopolymer polypropylene (PP). The PVDF 11010 was fed to the bottom manifold of the multi-manifold die with a 25 mm twin screw extruder at 18.2 kg/hr. (40 lbs./hr.). The TEXIN 285 was fed to the center manifold of the multi-manifold die with a 31 mm single screw extruder at 18.2 kg/hr. (40 lbs./hr.). The PP was fed to the top manifold of multi-manifold die with a 31 mm single screw extruder at 18.2 kg/hr. (40 lbs./hr.). The multilayer polymeric film was cast onto a chilled roll at 5.54 meters/minute (18 fpm) to a thickness of 75 micrometers. The surface structure on the polymeric film was formed by contacting the outer major surface of the first layer of the polymeric film (i.e., the PVDF 11010 layer) with a patterned casting roll at 82° C. and using a rubber nip roll applying a nip force of 5.965 kg per cm (33 pounds per lineal inch) of film width and a line speed of 5.5 meters per minute (18 feet per minute). Patterned casting roll targeted a “skip tooth” pattern, with 80 micrometer tall linear prism features having an 80 micrometer base and spaced apart by 150 micrometers. The included peak angle on the microreplicated features was 53 degrees. The extrusion replicated multilayer film made using this process and patterned casting roll had rounded tips with a peak to valley height of 64 micrometers.

### Example 6

### Microreplicated Film made Via Hot Pressing of a THV500 Film

To make this film, an acrylate tool having a continuous riblet pattern with peaks 100 micrometer tall, and peak-to-peak spacing of 100 micrometers and having included peak angle on the microreplicated features of 53 degrees was used. The acrylate tool was placed on top of a 5-mil (about 130 micrometers) thick THV500 film, inside a vacuum bag. A vacuum was drawn continuously and the bag was placed inside a 350° F. (177° C.) oven for 1 hour. After sample temperature cooled to less than 150° F. (66° C.), the embossed THV500 film was peeled away from the acrylate tool, without leaving acrylate residue on the THV500 film's riblet surface.

### Example 7

### Microreplicated Film, made Via Extrusion of HTE 1705

HTE 1705 was extruded using a 25 mm twin screw extruder at 18.2 kg/hr (40 pph) through a flat film die onto a patterned casting roll. The surface structure on the polymeric film was formed by contacting the outer major surface of the first layer of the polymeric film with a patterned casting roll at 82° C. and using a rubber nip roll applying a nip force of 5.965 kg per cm (33 pounds per lineal inch) of film width and a line speed of 5.5 meters per minute (18 feet per minute). Patterned casting roll targeted a “skip tooth” pattern, with 80 micrometer tall linear prism features having an 80 micrometer base and spaced apart by 150 micrometers. The included peak angle on the microreplicated features was 53 degrees.

Extrusion replicated HTE 1705 made using this process and patterned casting roll had rounded tips with a peak to valley height of 46 micrometers.

### Example 8

### Multilayer Microreplicated Film made Via Coextrusion of THV815, TEXIN 285, and PP

A multilayer extrusion replicated polymeric film was made using a 3 layer multi-manifold die to coextrude a first layer of THV815, a second layer of thermoplastic polyurethane TEXIN 285, and a third layer of a homopolymer polypropylene (PP). The THV815 was fed to the bottom manifold of the multi-manifold die with a 25 mm twin screw extruder at 18.2 kg/hr. (40 lbs./hr.). The TEXIN 285 was fed to the center manifold of the multi-manifold die with a 31 mm single screw extruder at 18.2 kg/hr. (40 lbs./hr.). The PP was fed to the top manifold of multi-manifold die with a 31 mm single screw extruder at 18.2 kg/hr. (40 lbs./hr.). The multilayer polymeric film was cast onto a chilled roll at 5.54 meters/minute (18 fpm) to a thickness of 75 micrometers. The surface structure on the polymeric film was formed by contacting the outer major surface of the first layer of the polymeric film with a patterned casting roll at 82° C. and using a rubber nip roll applying a nip force of 5.965 kg per cm (33 pounds per lineal inch) of film width and a line speed of 5.5 meters per minute (18 feet per minute). Patterned casting roll had 80 micrometer tall linear prism features having an 80 micrometer base and spaced apart by 150 micrometers. The included peak angle on the microreplicated features was 53 degrees. Extrusion replicated THV815 made using this process and patterned casting roll had rounded tips with a peak to valley height of 64 micrometers.

### Example 9

Starting with the film of Comparative Example 1, a riblet structure was added as follows: an acrylate tool having a continuous riblet pattern with peaks 100 micrometer tall, and peak-to-peak spacing of 100 micrometers and having included peak angle on the microreplicated features of 53 degrees was used for embossing a polypropylene film (12 mils thick), and then this embossed polypropylene film was used as a tool to emboss the polyurethane film of Comparative Example 1. The microreplicated surface of this embossed polyurethane film was then coated with the THV/PU interpenetrated network (2 mils thick) described in WO2015/069502, followed by treatment in a 150 C oven for 3 minutes. This was an exemplary embodiment of the film 100 shown in FIG. 1.

### Example 10

The microreplicated film of Example 1 was heat laminated (280° F., 138° C.) onto a printed 8671 polyurethane film.

### Example 11

The microreplicated film of Example 2 was heat laminated (280° F., 138° C.) with a printed 8671 polyurethane film. This was an exemplary embodiment of the film 200 shown in FIG. 2, including a surface 214 having reactive ion treatment.

### Example 12

The microreplicated film of Example 3 was heat laminated (280° F., 138° C.) with a printed 8671 polyurethane film.

### Example 13

This microreplicated film of Example 4 was heat laminated (280° F., 140° C.) with a printed 8671 polyurethane film. Confocal microscopy confirmed that the riblet microstructure survived the lamination process, having an average peak to valley height of about 45 micrometers. This was an exemplary embodiment of the film 200 shown in FIG. 2, including a surface 214 having reactive ion treatment.

### Example 14

The microreplicated film of Example 5 was heat laminated (280 F, 140 C) with a printed 8671 PU film. This was an exemplary embodiment of the film 300 shown in FIG. 3

SKYDROL Resistance Test 1 (and results)

In this test, a droplet of SKYDROL LD-4 was placed on top of the test film sample, so that the SKYDROL LD-4 didn't leak via the edge of the film sample to attack the polyurethane or adhesives layers underneath the top surface of the film sample.

A 2 ml drop of SKYDROL LD-4 each on top of Comparative Example 1 and Comparative Example 2. After 44 hours, visually we could see the Comparative Example 1's polyurethane top layer blister and delaminated from the ink layer. The ink layer also swelled and blistered. After 44 hours, the SKYDROL LD-4 still sat on top of the THV500 layer on Comparative Sample Comparative Example 2. After 7 days, visually we still saw the SKYDROL LD-4 sat on top of the THV500 layer, with no damage to the printed pattern underneath.

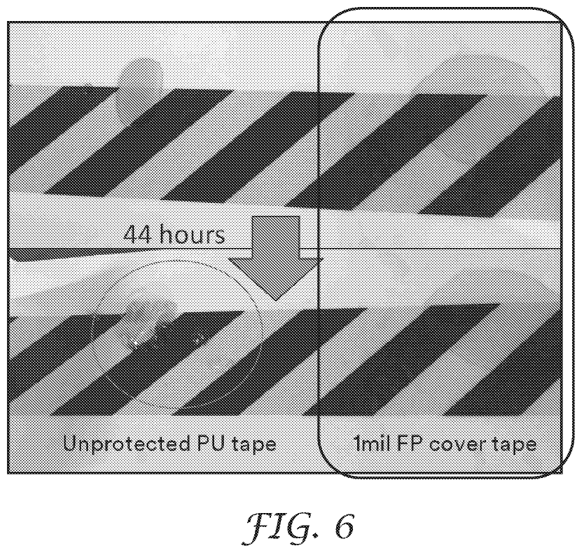

We learned from Comparative Example 1 that the 1-mil (about 25 micrometers) thick THV500 film sample was able to withstand SKYDROL LD-4 for at least a week. A 12-mil (about 305 micrometers) thick PU layer was not able to withstand SKYDROL LD-4 for 1 day, as shown in FIG. 6.

In FIG. 6, the initial condition of the unprotected PU layer (upper left) was visually unaffected by the droplet of SKYDROL LD-4, but after 44 hours, the condition of the unprotected PU layer (lower left) was visually degraded in the region of the SKYDROL LD-4 liquid. On the right side of FIG. 6, no degradation of the PU layer was visually observed, in the region covered by a fluoropolymer (“FP”) cover tape (i.e., the Comparative Example 2 construction, where the fluoropolymer was THV500).

SKYDROL Resistance Test 2 (and results)

A CONTROLTAC liner was peeled from the bottom of both samples Example 11 and Example 13, and then taped Example 11 and Example 13 samples to 4 inch by 4 inch (10 cm by 10 cm) aluminum coupons. The edges of the tapes were sealed with 3M ES2000 edge seal (“3M EDGE SEALER ES2000”, 3M Co., St. Paul, Minn.). To eliminate the edge effect caused by the limited SKYDROL LD-4 resistivity by ES2000, sufficient ES2000 to form a 3 mm high×4 mm wide edge. The test coupon was then left in room condition for 72 hours to completely cure the ES2000.

The test coupons were next submerged in SKYDROL LD4 bath for 7 days. After 7 days, there was visually no damage or blisters to the samples Example 11 and Example 13. When tweezers were manually scrubbed across the film surface, a squeeze sound could be heard, consistent with intact riblet patterns.

After Example 11 and Example 13 were submerged in SKYDROL LD-4 for 31 days, there was no visually observable damage to the samples. When tweezers were manually scrubbed across the film surface, a squeeze sound could be heard, consistent with intact riblet patterns.

After Example 11 and Example 13 were submerged in SKYDROL LD-4 for 90 days, the ES2000 edge seal failed. The SKYDROL LD-4 attacked the polyurethane layer underneath the fluoropolymer layer. However, the riblets on the PVDF and coPVDF films could still be felt by manually scrubbing the surface of the film with tweezers.

SKYDROL Resistance Test 3 (and results)

A 1 ml drop of SKYDROL LD-4 was placed on the film surface of EXAMPLE 9. After 1 day, visual observation showed that the SKYDROL LD-4 leaked underneath the TPU/THV coating and attacked the PU layer. However, in some spots, the SKYDROL LD-4 still remained on top of the film.

### Peel Test Data

The tapes of Examples 10 to 14 were tested in the 180-DEGREE PEEL TEST, with results as summarized in Tables 2A and 2B below.

TABLE 2A

| | +10° C. | +10° C. | 0° C. | 0° C. | −10° C. | −10° C. |
|---|---|---|---|---|---|---|
| | peak force, | average peel | peak force, | average peel | peak force, | average peel |
| | lbs/in | force, lbs/in | lbs/in | force, lbs/in | lbs/in | force, lbs/in |
| Sample | (N/cm) | (N/cm) | (N/cm) | (N/cm) | (N/cm) | (N/cm) |
| EX-10 | 0.24 (0.42) | 0.087 (0.15) | 0.44 (0.77) | 0.080 (0.14) | 0.32 (0.56) | 0.083 (0.15) |
| EX-11 | 10.0 (17.5) | break | 9.95 (17.4) | break | 3.21 (5.62) | 0.52 (0.91)* |
| EX-12 | 0.44 (0.77) | 0.13 (0.23) | 1.69 (2.96) | 0.22 (0.39) | 1.05 (1.84) | 0.16 (0.28) |
| EX-13 | 21.2 (37.2) | 19.3 (33.7)** | 26.1 (45.7) | break | 26.3 (46.1) | break |
| EX-14 | 16.5 (28.9) | 11.9 (20.9) | 14.5 (25.3) | 12.8 (22.4) | 14.7 (25.6) | 11.4 (19.9) |

TABLE 2B

| | −20° C. | −20° C. | −30° C. | −30° C. | −40° C. | −40° C. |
|---|---|---|---|---|---|---|
| | peak force, | average peel | peak force, | average peel | peak force, | average peel |
| | lbs/in | force, lbs/in | lbs/in | force, lbs/in | lbs/in | force, lbs/in |
| Sample | (N/cm) | (N/cm) | (N/cm) | (N/cm) | (N/cm) | (N/cm) |
| EX-10 | 0.24 (0.42) | 0.087 (0.15) | 0.17 (0.30) | 0.13 (0.23) | 0.43 (0.75) | 0.30 (0.53) |
| EX-11 | 2.37 (4.15) | 0.48 (0.84) | 1.58 (2.77) | 0.69 (1.2) | 0.76 (1.33) | 0.56 (0.98) |
| EX-12 | 0.61 (1.1) | 0.18 (0.32) | 0.85 (1.5) | 0.49 (0.86) | 0.49 (0.86) | 0.45 (0.79) |
| EX-13 | 13.4 (23.5) | break | 18.0 (31.5) | break | 15.9 (27.8) | break |
| EX-14 | 14.6 (25.5) | 12.0 (21.0) | 14.4 (25.2) | 14.0 (24.4)** | 14.9 (26.1) | break |

In Tables 2A and 2B:
“*”=one of three tape samples broke during the test;
“**”=two of three tape samples broke during the test; and
“break”=all three tape samples broke during the test.

All cited references, patents, and patent applications in the above application for letters patent are herein incorporated by reference in their entirety in a consistent manner. In the event of inconsistencies or contradictions between portions of the incorporated references and this application, the information in the preceding description shall control. The preceding description, given in order to enable one of ordinary skill in the art to practice the claimed disclosure, is not to be construed as limiting the scope of the disclosure, which is defined by the claims and all equivalents thereto.

1. A surfacing film comprising:
a surface layer having opposed first and second major surfaces, the first major surface comprising a fluoropolymer surface and the second major surface comprising a nanostructured surface; and
a printed layer disposed on the second major surface and at least partially embedded in the nanostructured surface.

2. The surfacing film of claim 1, wherein the nanostructured surface comprises a plasma reactive ion etched surface.

3. The surfacing film of claim 1, further comprising an adhesive layer extending across at least a portion of the printed layer.

4. The surfacing film of claim 3, further comprising a support layer disposed between the adhesive layer and the printed layer.

5. The surfacing film of claim 4, wherein the support layer comprises polyurethane or poly(methyl methacrylate).

6. The surfacing film of claim 1, wherein the first major surface has a microreplicated surface.

7. The surfacing film of claim 6, wherein the microreplicated surface comprises a plurality of ridges defining capillary channels.

8. The surfacing film of claim 1, wherein the support layer is pigmented, the printed layer is discontinuous, and the support layer is at least partially embedded in the nanostructured surface.

9. (canceled)

10. (canceled)

11. A surfacing film comprising:
a surface layer having opposed first and second major surfaces, the first major surface comprising a fluoropolymer surface;
a tie layer underlying the surface layer, wherein the surface layer and the tie layer are coextruded layers; and
a printed layer disposed on the tie layer.

12. A surfacing film comprising:
a surface layer having opposed first and second major surfaces; and
an adhesive layer extending across the second major surface,
wherein the first major surface comprises a fluoropolymer surface comprises a microreplicated surface and wherein delamination peel strength of the surface layer from the remaining layers is greater than the tensile strength of the surface layer based on the 180° Peel Test.

13. The surfacing film of claim 1, wherein the fluoropolymer surface comprises a copolymer of vinylidene fluoride and hexafluoropropylene.

14. A method of using the surfacing film of claim 1, comprising applying the surfacing film to an outer surface of an aircraft component to enhance friction.

15. (canceled)
